(19) United States
(12) Patent Application Publication
(10) Pub. No.: US 2016/0316493 A1
(43) Pub. Date: Oct. 27, 2016

(54) Next Generation Public-Safety Answering Point (PSAP) Administration via Text Messaging

(71) Applicant: TeleCommunication Systems, Inc., Annapolis, MD (US)

(72) Inventors: Matthew Davis, St. Johnsbury, VT (US); Jeremy Jackson, West Burke, VT (US)

(21) Appl. No.: 14/695,025

(22) Filed: Apr. 23, 2015

(51) Int. Cl. H04W 76/00; H04W 4/14; H04M 3/51

(52) U.S. Cl. CPC H04W 76/007; H04M 3/5116; H04W 4/14; H04W 4/22

(57) ABSTRACT

A PSAP management system includes a mobile device and a Short Message Service (SMS) enabled ESRP(s). The mobile device can include a PSAP administrator module that allows a PSAP administrator to initiate transmission of a text message to a Short Message Service (SMS) enabled ESRP(s). The text message can be comprised of management commands that allow the PSAP administrator to remotely manage, e.g., take a particular PSAP offline, place a particular PSAP online, redirect overflow to a particular PSAP, direct maintenance to a particular PSAP, direct disaster calls to a particular PSAP, etc., one or more PSAPs. The PSAPs can be managed due to such external factors as, e.g., communication problems with a particular PSAP, power outage at a particular PSAP, localized emergencies requiring greater bandwidth, etc.

### BACKGROUND OF THE INVENTION

1. Field of the Invention

The present invention relates to Public Safety Answering Point (PSAP) management. More particularly, the present invention relates to text message based management of one or more PSAPs via an Emergency Services Routing Proxy (ESRP).

2. Background of Related Art

PSAPs are emergency call centers distributed throughout the country. PSAPs are responsible for answering emergency 911 calls seeking assistance from police, fire, and medical personnel. PSAP operators field these emergency 911 calls and dispatch emergency services according to a type of service requested by a caller.

FIG. 5 illustrates a conventional legacy PSAP system.

In the legacy PSAP system 500 shown in FIG. 5, PSAP-A 520 and PSAP-B 530 utilizing Enhanced multi-frequency (MF) or Centralized Automatic Message Accounting (CAMA) emergency call trunks 540 that terminate from a selective router 510.

The PSAP operators 522 and 532 of their respective PSAPs, PSAP-A 520 and PSAP-B 530, have what is referred to as ‘kill switches’ 524 and 534. The kill switches 524 and 534 are essentially hardware switches that will drop voltage on an emergency call trunk 540 and force the selective router 510 into a failover scenario. For example, the failover scenario can direct calls that would have been routed to PSAP-A 520 to be routed to PSAP-B 530 instead.

Conventionally, PSAPs executed with Emergency Service Internet Protocol (IP) network (ESINet) technology require a voice phone call to personnel at a Network Operations Center (NOC) that has authority to take a PSAP offline and send emergency calls to an alternate PSAP. The NOC personnel respond to the voice phone call accordingly.

An Emergency Services Routing Proxy (ESRP) exists that includes an embedded, but not functional, interactive voice response (IVR) system. This IVR system allows a PSAP operator to call a phone number and utilize a text to speech interactive menu to take a PSAP offline and send emergency calls to an alternate PSAP. This IVR based process is cumbersome, requiring entry of agent identification and passwords.

Accordingly, there is a need for a more PSAP administrator friendly way of administrating an ESRP servicing a plurality of PSAPs.

### SUMMARY OF THE INVENTION

In accordance with the principles of the present invention, a mobile device is comprised of a Public-safety Answering Point (PSAP) administration module to generate a text message including management commands to manage at least one PSAP from a plurality of PSAPs. A transmitter transmits the text message to an Emergency Services Routing Proxy (ESRP), wherein the ESRP manages the at least one PSAP in accordance with the management commands.

A method of managing a Public-safety Answering Point (PSAP) in accordance with another aspect of the present invention comprises generating, with a Public-safety Answering Point (PSAP) administration module of a mobile device, a text message including management commands to manage at least one PSAP from a plurality of PSAPs, and transmitting, from the mobile device, the text message to an Emergency Services Routing Proxy (ESRP). The ESRP manages the at least one PSAP in accordance with the management commands.

In accordance with yet another aspect of the present invention, an Emergency Services Routing Proxy (ESRP) is comprised of a Public-safety Answering Point (PSAP) manager module to receive a text message, from a mobile device, including management commands. The PSAP management module manages at least one PSAP from a plurality of PSAPs in accordance with the received management commands.

A method of managing a Public-safety Answering Point (PSAP) in accordance with yet another aspect of the present invention comprises receiving, at an Emergency Services Routing Proxy (ESRP), a text message from a mobile device, the text message including management commands to manage at least one PSAP from a plurality of PSAPs, and managing the at least one PSAP in accordance with the management commands.

### BRIEF DESCRIPTION OF THE DRAWINGS

Features and advantages of the present invention will become apparent to those skilled in the art from the following description with reference to the drawings, in which:

FIG. 1 illustrates an exemplary PSAP management system having apparatuses for managing one or more PSAPs, in accordance with the principles of the present invention.

FIG. 2 illustrates the relevant features of an exemplary mobile device and Short Message Service (SMS) enabled ESRP(s), in accordance with the principles of the present invention.

FIG. 3 illustrates an exemplary mobile device process by which a mobile device generates and transmits a text message including management commands and/or status update requests to an SMS enabled ESRP(s), in accordance with the principles of the present invention.

FIG. 4 illustrates an exemplary SMS enabled ESRP(s) process by which an SMS enabled ESRP(s) 145 receives, from a mobile device, and processes a text message, in accordance with the principles of the present invention.

FIG. 5 illustrates a conventional legacy PSAP system.

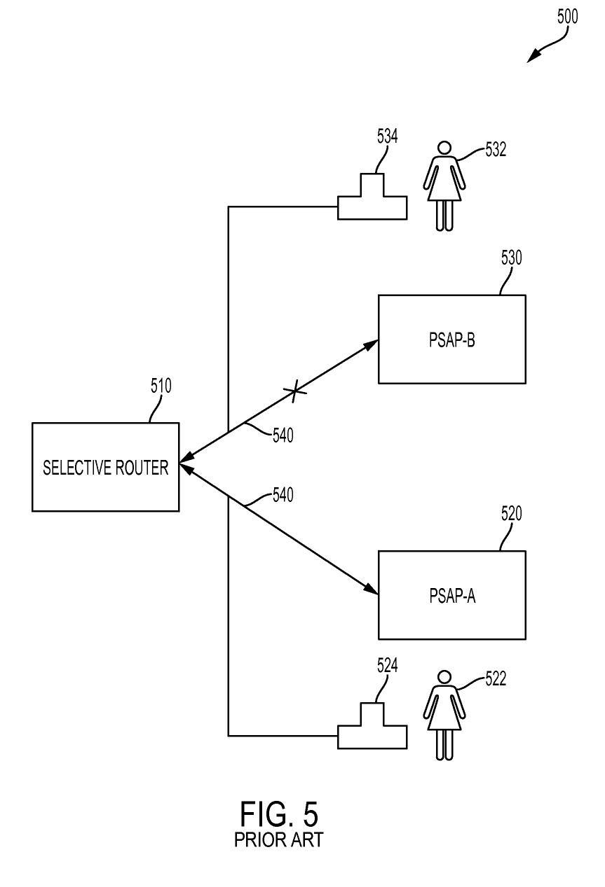

### DETAILED DESCRIPTION OF ILLUSTRATIVE EMBODIMENTS

The present inventors have appreciated that there is a need for a convenient way to manage one or more PSAPs within an ESINet and/or Request for Assistance Interface (RFAI) network.

The present invention can be comprised of a PSAP management system that includes a mobile device and one or more Short Message Service (SMS) enabled ESRP(s). The mobile device can include a PSAP administrator module that allows a PSAP administrator to initiate a text session to transmit a text message to the SMS enabled ESRP(s). The text message can be comprised of one or more management commands that allow the PSAP administrator to remotely manage, e.g., take a PSAP offline, place a PSAP online, redirect overflow to a particular PSAP, direct maintenance to a particular PSAP, direct disaster calls to a particular PSAP, set a PSAP to a normal state, etc., one or more PSAPs (bulk PSAP administration). However, a particular PSAP may be bound to a long term policy for call routing that may limit and/or prevent a PSAP administrator from remotely managing the particular PSAP. The one or more PSAPs can be managed due to such external factors as, e.g., communication problems with a particular PSAP, power outage at a particular PSAP, localized emergencies requiring greater bandwidth, etc.

The SMS enabled ESRP(s) can be comprised of a PSAP management module that receives the text message transmitted by the mobile device, and performs management functions in accordance with the management commands included with the text message. In one embodiment, the SMS enabled ESRP(s) can respond to the text message by transmitting status update information back to the PSAP administrator via the mobile device.

Thus, the inventive mobile device and SMS enabled ESRP(s) disclosed herein enable a PSAP administrator to conveniently manage, via text messaging, one or more PSAPs within an ESINet.

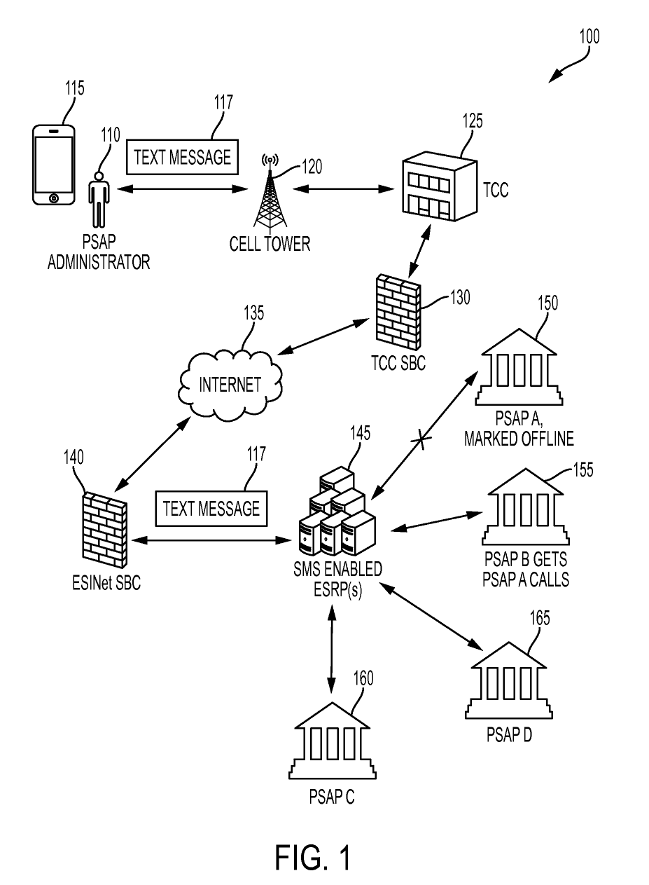

FIG. 1 illustrates an exemplary PSAP management system 100 having apparatuses for managing one or more PSAPs 150, 155, 160, 165, in accordance with the principles of the present invention.

The PSAP management system 100 can comprise physical apparatuses that include a mobile device 115, a cell tower 120, a text control center (TCC) 125, a TCC session border controller (SBC) 130, a communication network (e.g., the Internet 130), an ESINet SBC 140, one or more SMS enabled ESRP(s) 145, and a plurality of PSAPs, PSAP-A 150, PSAP-B 155, PSAP-C 160, and PSAP-D 165.

Four PSAPs 150, 155, 160, 165 are shown in FIG. 1 for simplicity of illustration, where the inventive PSAP management system 100 disclosed can accommodate an unlimited number of PSAPs. Likewise, a single PSAP administrator 110 is shown for simplicity of illustration, where the inventive PSAP management system 100 disclosed can accommodate an unlimited number of PSAP administrators.

The apparatuses 115, 120, 125, 130, 135, 140, 145, 150, 155, 160, 165 of the PSAP management system 100 can include various physical components (not shown) required for operability that include, e.g., an appropriate processor, microprocessor, microcontroller, digital signal processor (DSP), digital storage (e.g., random access memory (RAM), read-only memory (ROM), hard disk (HD) storage, solid state disk (SSD) storage), a screen, input devices (e.g., keyboard, mouse, camera), etc. The apparatuses 115, 120, 125, 130, 135, 140, 145, 150, 155, 160, 165 can execute one or more operating systems.

The PSAP administrator 110 can generate a text message 117 including one or more management commands, request for status update information for a particular PSAP, and a request for ‘HELP’ on the mobile device 115. The mobile device 115 can initiate a text session and transmit the text message 117 to the SMS enabled ESRP(s) 145, via the various communication network components 120, 125, 130, 135, 140 along the communication path between the mobile device 115 and the SMS enabled ESRP(s) 145.

The mobile device 115 can transmit the text message 117 to a cellular network, e.g., cell tower 120, where the cell tower 120 can direct the text message 117 to the TCC 125. The TCC 125 can process the text message 117 out toward the TCC SBC 130 (or other Bridge Control Facility (BCF) facing an ESINet, where the TCC SBC 130 can direct the text message 117 onto an IP network (e.g., Internet 135). From the Internet 135 the text message 117 can be directed to the ESINet SBC 140, where the ESINet SBC 140 can direct the text message 117 to the SMS enabled ESRP(s) 145.

The text message 117 can be transmitted from the TCC 125 toward the ESINet via Transmission Control Protocol (TCP)/IP leveraging Session Initiation Protocol (SIP) protocol. The protocols between the SMS enabled ESRP(s) 145 and the TCC SBC 130 can include SIP/Message Session Relay Protocol (MSRP) messaging and either of TCP or User Datagram Protocol (UDP) transport protocol.

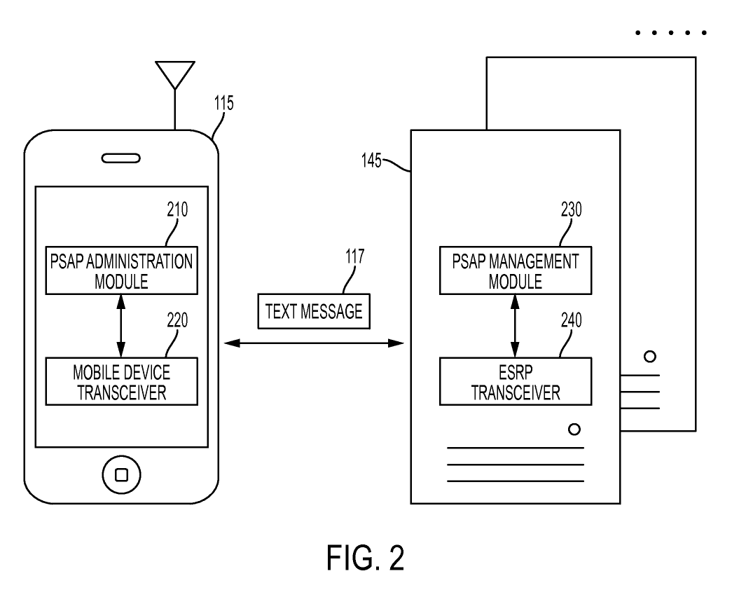

FIG. 2 illustrates the relevant features of the exemplary mobile device 115 and the SMS enabled ESRP(s) 145, in accordance with the principles of the present invention.

In particular, as shown in FIG. 2, the mobile device 115 can include a PSAP administration module 210 and a mobile device transceiver 220. The SMS enabled ESRP(s) 145 can include a PSAP management module 230 and an ESRP transceiver 240.

The PSAP administration module 210 can generate and initiate transmission, via the mobile device transceiver 220, of the inventive text message 117 disclosed herein. The PSAP administration module 210 can transmit the text message 117 utilizing a full 10 digit number, a short code and/or process the text message 117 as a 911 text message. The PSAP administration module 210 can be a conventional text messaging application built into and/or downloadable to the mobile device 115 that can allow a user of the mobile device 115 to text message other mobile devices. In one embodiment, PSAP administration module 210 can be a custom programmed text messaging application including custom menu(s) and/or button(s) associated with pre-configured text message(s) that allow the PSAP administrator 110 to select pre-configured options for managing the PSAPs 150, 155, 160, 165, as discussed in more detail below.

The PSAP administration module 210 can be implemented as a cell phone ‘app’ (e.g., iOS app) that that can be distributed to PSAP administrators to remotely manage one or more of the PSAPs 150, 155, 160, 165. The app implemented PSAP administration module 210 can be configured to display real time and historical statistics from the ESINet within the app, and even provide real time PSAP state information. The PSAP administrator module 210 can provide a PSAP administrator 110 with menu options for displaying graphical statistics including, e.g., call volume for a past day: return number of calls and average duration, call volume for a past week: return number of calls and average duration, call volume for a past month: return number of calls and average duration, an option to return to a previous menu, etc.

The app implemented PSAP administration module 210 can allow the PSAP administrator 110 to schedule planned downtime, recurring downtime events (e.g., nightly PSAP shutdown), and/or provide for other types of management of the one or more PSAPs 150, 155, 160, 165 by the PSAP administrator 110, as discussed herein.

The PSAP management module 230 can receive the text message 117, via the ESRP transceiver 240, analyze the text message 117, and determine that the text message 117 is a request to manage one or more of the PSAPs 150, 155, 160, 165, and/or a request for statistical information associated with one or more of the PSAPs 150, 155, 160, 165.

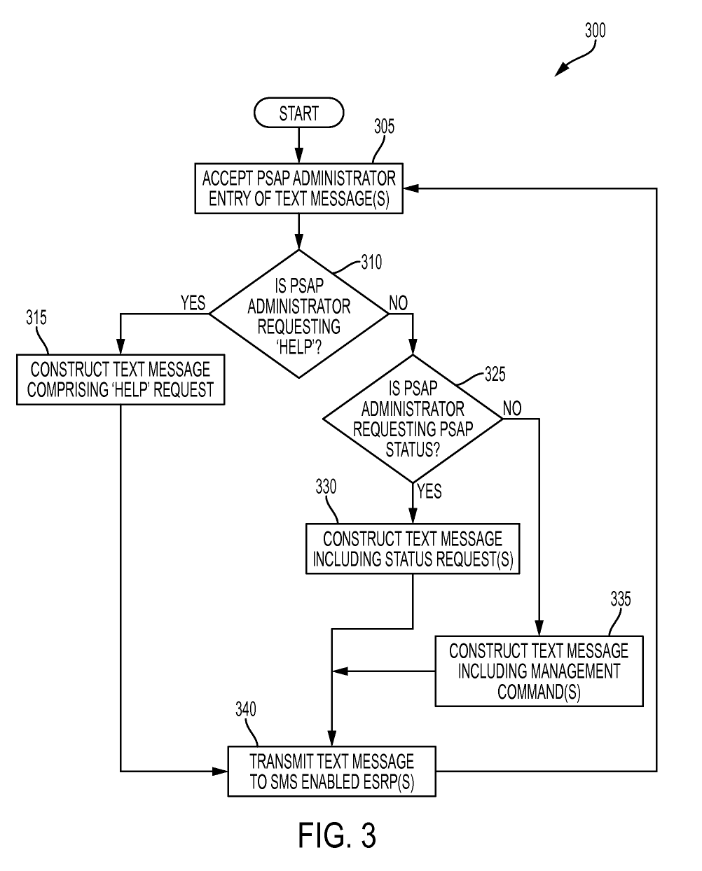

The functions of the components of the exemplary mobile device 115 shown in FIGS. 1 and 2 will be described with reference to FIG. 3.

FIG. 3 illustrates an exemplary mobile device process 300 by which the mobile device 115 generates and transmits a text message 117 including management commands and/or status update requests to an SMS enabled ESRP(s) 145, in accordance with the principles of the present invention.

In step 305 of the exemplary mobile device process 300, the PSAP administration module 210 of the mobile device 115 can accept entry of text data from a PSAP administrator 110. The PSAP administrator 110 can enter text data into a physical or virtual keyboard, depending on the type of mobile device 115 being employed by the PSAP administrator 110. The PSAP administration module 210 can include custom text messages pre-provisioned into the mobile device 115 to simplify and speed generation of the text message 117. Step 305 can branch to step 310.

The PSAP administration module 210 of the mobile device 115 can provide pre-designated fields for entry of specific types of information by the PSAP administrator 110. For example, the PSAP administrator module 210 can provide entry boxes designated for and allowing entry of, e.g., identification of target PSAP, requested type of management function to be performed, a start time for the management function, an end time for the management function, an alternate PSAP to take over functions of a disabled PSAP, a PSAP to disable once an alternate PSAP is enabled, etc.

The PSAP administrator module 210 of the mobile device 115 can provide an entry box to allow a PSAP administrator 110 to enter text data, select text message(s) 117 from a drop down menu of text message(s) 117 that can be transmitted to the SMS enabled ESRP(s) 145, and/or provide virtual button options of text message(s) 117 that can be transmitted to the SMS enabled ESRP(s) 145.

Another embodiment can employ text-to-speech to allow a PSAP administrator 110 to provide verbal commands. The PSAP administrator module 210 can convert the verbal commands to text commands via a speech-to-text conversion capability of the PSAP administrator module 210, or a speech-to-text capability built into the mobile device 115.

The PSAP administrator 110 can exit a text session with the SMS enabled ESRP(s) 145 at any time desired. For example, the PSAP administrator can enter ‘STOP’ to exit a text session with the SMS enabled ESRP(s) 145.

In step 310, the PSAP administration module 210 of the mobile device 115 can analyze the text data entered by the PSAP administrator 110 in step 305 and determine if the PSAP administrator 110 is requesting ‘HELP’. If the PSAP administration module 210 determines that the PSAP administrator 110 is requesting help, step 310 branches to step 315. Otherwise, step 310 branches to step 325.

In step 315, the PSAP administrator module 210 can construct a text message 117 that includes the word ‘HELP’ in response to the PSAP administrator 110 requesting help. Step 315 can branch to step 340.

In step 340, the mobile device 115 transmits, via the mobile device transceiver 220, the text message 117 including the word ‘HELP’ to the SMS enabled ESRP(s) 145. Step 340 can branch to step 305 to allow the PSAP administrator 110 to continue entry of text data resulting in construction of additional text messages 117.

In step 325, the PSAP administrator module 210 of the mobile device 115 can determine if the PSAP administrator is requesting a status update for one or more PSAPs 150, 155, 160, 165. If the PSAP administration module 210 determines that the PSAP administrator 110 is requesting a status update for one or more PSAPs 150, 155, 160, 165, step 325 branches to step 330. Otherwise, step 325 branches to step 335.

In step 330, the PSAP administrator module 210 of the mobile device 115 can construct the text message 117 that includes a status update request with text data entered in step 305. The text message 117 can identify a particular PSAP that the PSAP administrator 110 desires status information about, or identify a group of PSAPs that the PSAP administrator 110 desires status information about. Step 330 can branch to step 340.

In step 340, the mobile device 115 transmits, via the mobile device transceiver 220, the text message 117 including a status update request to the SMS enabled ESRP(s) 145. Step 340 can branch to step 305 to allow the PSAP administrator 110 to continue entry of text data resulting in construction of one or more additional text messages 117.

In step 335, the PSAP administrator module 210 of the mobile device 115 can construct a text message 117 that includes management commands provided by the PSAP administrator 110 in step 305. The PSAP administrator module 210 can format the text message 117 to include the PSAP administrator's 110 desired actions into pre- designated fields corresponding to management commands that can be accessed by the corresponding PSAP management module 230 of the SMS enabled ESRP(s) 145. Step 335 can branch to step 340.

In step 340, the mobile device 115 transmits, via the mobile device transceiver 220, the text message 117 including management commands to the SMS enabled ESRP(s) 145. Step 340 can branch to step 305 to allow the PSAP administrator 110 to continue entry of text resulting in construction of additional text messages.

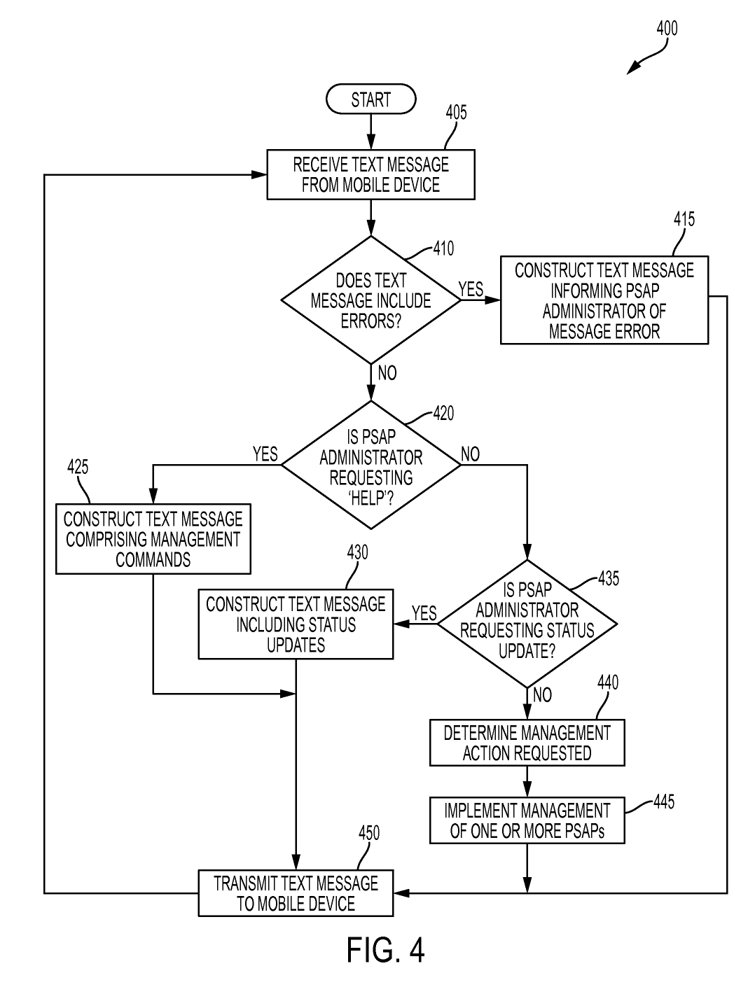

The functions of the components of the exemplary SMS enabled ESRP(s) 145 shown in FIGS. 1 and 2 will be described with reference to FIG. 4.

FIG. 4 illustrates an exemplary SMS enabled ESRP(s) process 400 by which the SMS enabled ESRP(s) 145 receives, from the mobile device 115, and processes the text message 117, in accordance with the principles of the present invention.

In step 405 of the exemplary SMS enabled ESRP(s) process 400, the PSAP management module 230, via the ESRP transceiver 240, can receive one or more text messages 117 from the mobile device 115 via an established text session. The SMS enabled ESRP(s) 145 can receive a SIP message and process the SIP message as a text message 117. The PSAP management module 230 can determine that the SMS enabled ESRP(s) 145 should enter a PSAP management text session based on a texted number or caller's callback number (e.g., PSAP administrator's 110 callback number). Step 405 can branch to step 410.

In step 410, the PSAP management module 230 of the SMS enabled ESRP(s) 145 can determine if the text message 117 received in step 405 contain an error. The PSAP management module 230 can analyze the text message 117 received by the SMS enabled ESRP(s) 145 in step 405 to determine whether the text message 117 contains one or more errors, e.g., the text message 117 is blank, the text message 117 lacks full formatting, the text message 117 lacks authentication, the text message 117 includes invalid commands, the text message 117 is incomplete and missing commands, etc. If the PSAP management module 230 determines that there is an error associated with the text message 117, step 410 can branch to step 415. Otherwise, step 410 branches to step 420.

In step 415, the PSAP management module 230 of the SMS enabled ESRP(s) 145 can construct a text message 117. The text message 117 constructed in step 415 can include an error message informing the PSAP administrator 110 of specific problems associated with a request from the PSAP administrator 110. Step 415 can branch to step 450.

In step 450, the SMS enabled ESRP(s) 145, via the ESRP transceiver 240, can transmit via an established text session a text message 117 informing a PSAP administrator 110 of error(s) within a text message 117 received in step 405. Step 450 can branch to step 405 to allow the SMS enabled ESRP(s) 145 to continue to receive one or more additional text messages 117.

In step 420, the PSAP management module 230 of the SMS enabled ESRP(s) 145 can determine if the PSAP administrator 110 is requesting help. For example, the PSAP management module 230 can analyze the text message 117 received by the SMS enabled ESRP(s) 145 in step 405 to determine that a keyword, e.g., ‘HELP’, is included within the text message 117. If the PSAP management module 230 determines that the PSAP administrator 110 is requesting help, step 420 branches to step 425. Otherwise, step 420 branches to step 435.

In step 425, the PSAP management module 230 of the SMS enabled ESRP(s) 145 can construct a text message 117 comprising a listing of management commands and syntax to implement a particular management command. The list of management commands are management commands that are available to a PSAP administrator 110 for entry into a mobile device 115. As discussed above, the management commands are used by the PSAP administrator 110 to manage one or more of the PSAPs 150, 155, 160, 165 via the PSAP management module 230 of the SMS enabled ESRP(s) 145. Step 425 can branch to step 450.

In step 450, the SMS enabled ESRP(s) 145, via the ESRP transceiver 240, can transmit a text message 117 including the list of management commands to the mobile device 110. Step 450 can branch to step 405 to allow the SMS enabled ESRP(s) 145 to continue to receive one or more additional text messages 117.

In step 435, the PSAP management module 230 of the SMS enabled ESRP(s) 145 can determine if the PSAP administrator 110 is requesting a status update. The PSAP management module 230 can analyze the text message 117 received by the SMS enabled ESRP(s) 145 in step 405 to determine the text message 117 includes one or more key words, e.g., ‘STATUS REQUEST’. The one or more keywords can indicate that the PSAP administrator 110 is requesting a status update for one or more PSAPs 150, 155, 160, 165. If the PSAP management module 230 determines that the PSAP administrator 110 is requesting a status update of one or more PSAPs 150, 155, 160, 165, step 435 branches to step 430. Otherwise, step 435 branches to step 440.

In step 430, the PSAP management module 230 of the SMS enabled ESRP(s) 145 can construct a text message 117 that includes status updates. The PSAP management module 230 can poll one or more PSAPs 150, 155, 160, 165 to gather status update information, e.g., statistical data associated with one or more PSAPs 150, 155, 160, 165, such as number of active calls, number of calls received over a given period of time, number of PSAP operators available to accept emergency calls, whether a particular PSAP is active/disabled, etc. In one embodiment, the PSAP management module 230 can query a database that maintains status information for the PSAPs 150, 155, 160, 165. The PSAP management module 230 can construct a text message 117 that includes the status update information requested by the PSAP administrator 110. Step 430 can branches to step 450.

In step 450, the SMS enabled ESRP(s) 145, via the ESRP transceiver 240, can transmit a text message 117 including the status update information gathered in step 430 to the mobile device 110. Step 450 can branch to step 405 to allow the SMS enabled ESRP(s) 145 to continue to receive one or more additional text messages 117.

In step 440, the PSAP management module 230 of the SMS enabled ESRP(s) 145 can determine the type of management action requested by the PSAP administrator 110. The PSAP management module 230 can analyze the text data within the text message 117 received in step 405 to determine whether specific keywords, e.g., ‘take PSAP-A offline’, exist therein within the management commands. Step 440 can branch to step 445.

In step 445, the PSAP management module 230 of the SMS enabled ESRP(s) 145 can implement management of one or more PSAPs 150, 155, 160, 165. The PSAP management module 230 can implement management of one or more PSAPs 150, 155, 160, 165 in accordance with the management commands included in the text message 117 received in step 405. The PSAP management module 230 can leverage business logic to manage one or more PSAPs 150, 155, 160, 165 via a policy routing function. Step 445 can branch to step 450.

In one embodiment, the PSAP management module 230, via the PSAP transceiver 240, can reply to the mobile device 110 via an established text session to request confirmation of action prior to implementing management of one or more PSAPs 150, 155, 160, 165. The PSAP management module 230 can await reception of a subsequent text message 117 confirming one or more management actions requested prior to implementing one or more management commands. The PSAP management module 230 can generate a text message 117 that includes an authentication information request per an authentication scheme (e.g., PSAP ID, User, Password, etc.).

The PSAP management module 230 can delay implementation of any requested management commands until necessary authentication information is received by the PSAP management module 230. Authentication information for the PSAP administrator 110 can include a password entered by a PSAP administrator 110, an exchange within a text session between the PSAP administrator 110 and the PSAP management module 230 of pre-designated questions requiring pre-designated answers, biometric authentication, etc. In one embodiment, the PSAP administrator module 210 can utilize a fingerprint reader (not shown) built into the module device 115 to authenticate a PSAP administrator 110. The PSAP management module 230 can utilize other forms of biometric authentication including, e.g., signature dynamics, typing patterns, eye scans, hand or palm geometry, voice recognition, facial recognition, etc.

In step 450, the SMS enabled ESRP(s) 145, via the ESRP transceiver 240, can transmit a text message 117 to the mobile device 110 including confirmation of management function(s) performed by the SMS enabled ESRP(s) 145. Step 450 can branch to step 405 to allow the SMS enabled ESRP(s) 145 to continue to receive one or more additional text messages 117.

The present invention can be implemented in any mobile device that is configured to transmit text messages, including cell phones, laptop computers, table computers, etc.

While the invention has been described with reference to the exemplary preferred embodiments thereof, those skilled in the art will be able to make various modifications to the described embodiments of the invention without departing from the true spirit and scope of the invention.

1. A mobile device, comprising:
a Public-safety Answering Point (PSAP) administration module to generate a text message including management commands to manage at least one PSAP from a plurality of PSAPs, wherein said management commands are generated in predesignated fields within said text message that correspond to instructions that are accessible to an Emergency Services Routing Proxy (ESRP); and
a transmitter to transmit said text message to said ESRP;
wherein said ESRP manages said at least one PSAP in accordance with said instructions of said management commands.

2. The mobile device according to claim 1, wherein said text message is a Short Message Service (SMS) text message.

3. The mobile device according to claim 1, wherein said mobile device is a cellular telephone.

4. The mobile device according to claim 1, wherein said management commands instruct said ESRP to take offline at least one PSAP from said plurality of PSAPs.

5. The mobile device according to claim 1, wherein said PSAP administration module is a cell phone app.

6. The mobile device according to claim 1, wherein said text message further includes a status update request requesting a status update of said at least one PSAP from said plurality of PSAPs.

7. A method of managing a Public-safety Answering Point (PSAP), comprising:
generating, with a Public-safety Answering Point (PSAP) administration module of a mobile device, a text message including management commands to manage at least one PSAP from a plurality of PSAPs, wherein said management commands are generated in predesignated fields within said text message that correspond to instructions that are accessible to an Emergency Services Routing Proxy (ESRP); and
transmitting, from said mobile device, said text message to said ESRP;
wherein said ESRP manages said at least one PSAP in accordance with said management commands.

8. The method of managing a PSAP according to claim 7, wherein said text message is a Short Message Service (SMS) text message.

9. The method of managing a PSAP according to claim 7, wherein said mobile device is a cellular telephone.

10. The method of managing a PSAP according to claim 7, wherein said management commands instruct said ESRP to take offline at least one PSAP from said plurality of PSAPs.

11. The method of managing a PSAP according to claim 7, wherein said PSAP administration module is a cell phone app.

12. The method of managing a PSAP according to claim 7, wherein said text message further includes a status update request requesting a status update of said at least one PSAP from said plurality of PSAPs.

13. An Emergency Services Routing Proxy (ESRP), comprising:
a Public-safety Answering Point (PSAP) manager module to receive a text message, from a mobile device, including predesignated fields associated with respective management commands, wherein said management commands correspond to instructions that are accessible to said ESRP;
wherein said PSAP management module manages at least one PSAP from a plurality of PSAPs in accordance with said management commands.

14. The ESRP according to claim 13, wherein said text message is a Short Message Service (SMS) text message.

15. The ESRP according to claim 13, wherein said mobile device is a cellular telephone.

16. The ESRP according to claim 13, wherein said management commands instruct said ESRP to take offline said at least one PSAP from said plurality of PSAPs.

17. The ESRP according to claim 13, wherein said text message is transmitted by a cell phone app.

18. The ESRP according to claim 13, wherein said text message further includes a status update request requesting a status update of said at least one PSAP from said plurality of PSAPs.

19. A method of managing a Public-safety Answering Point (PSAP), comprising:
receiving, at an Emergency Services Routing Proxy (ESRP), a text message from a mobile device, said text message including predesignated fields associated with respective management commands to manage at least one PSAP from a plurality of PSAPs, wherein said management commands correspond to instructions that are accessible to said ESRP; and
managing said at least one PSAP in accordance with said management commands.

20. The method of managing a PSAP according to claim 19, wherein said text message is a Short Message Service (SMS) text message.

21. The method of managing a PSAP according to claim 19, wherein said mobile device is a cellular telephone.

22. The method of managing a PSAP according to claim 19, wherein said management commands instruct said ESRP to take offline said at least one PSAP from said plurality of PSAPs.

23. The method of managing a PSAP according to claim 19, wherein said text message is transmitted by a cell phone app.

24. The method of managing a PSAP according to claim 19, further comprising:
transmitting, from said Emergency Services Routing Proxy (ESRP), status update information in response to said text message including a status update request requesting a status update of at least one PSAP from a plurality of PSAPs.

25. The mobile device according to claim 1, wherein text within said text message is generated in response to user input at said mobile device.

26. The mobile device according to claim 1, wherein said ESRP comprises a PSAP management module to analyze said predesignated fields to determine a keyword associated with a particular management command.
